(19) United States
(12) Patent Application Publication
(10) Pub. No.: US 2003/0233348 A1
(43) Pub. Date: Dec. 18, 2003

(54) System and method for supplying company data

(76) Inventor: Richard Franklin, London (GB)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 10/172,779

(22) Filed: Jun. 14, 2002

(51) Int. Cl. G06F 7/00

(52) U.S. Cl. 707/3

(57) ABSTRACT

A method of providing information regarding companies to users, including entering multiple articles into an online database, prompting a user to submit a query from a remote terminal, searching the online database based on the query submitted by the user, and providing the user with information based on the results of the search, wherein the articles includes publicly available press releases released within a given time period relating to a particular industry group.

The present invention relates to providing information about companies. More particularly, the present invention relates to providing company data in an online format.

A vast number of press releases containing a tremendous amount of information are released every day. While it might seem possible to keep track of relevant press releases relating to companies and products of interest to an individual or organization, even such limited manual tracking is impractical for several reasons. For example, corporate mergers can often result in the tracked product being subsumed into a larger company, which should be tracked retroactively. A tool allowing a user to track all of the products and companies in an industry retrospectively as well as prospectively is therefore necessary.

### SUMMARY OF THE INVENTION

In one embodiment, the invention relates to a method of providing information regarding companies to users, including entering multiple articles into an online database, prompting a user to submit a query from a remote terminal, searching the online database based on the query submitted by the user, and providing the user with information based on the results of the search, wherein the articles includes publicly available press releases released within a given time period relating to a particular industry group.

In another embodiment, a method of providing information regarding companies to users, including entering multiple press releases into a database, associating one or more of a set of criteria with each article in the database using an engine, prompting a user to provide one or more search criteria, prompting the user to provide one or more search terms, searching the database based on the search criteria and search terms submitted by the user, and providing the user with information based on the results of the search.

In another embodiment, a computer-readable medium having stored thereon a data structure for storing information relating to companies, including an attribute relating to the text of an article, an attribute relating to the geographic location of the company, an attribute relating to the industry subsector of the company, and an attribute relating to the clinical area of the press release.

In another embodiment, a system for providing information relating to companies, including a processor, a memory in communication with the processor, a database stored in the memory, a display in communication with the processor, and an input device in communication with the processor, wherein the database includes all publicly available press releases released during a predetermined time period relating to a particular industry, and wherein in response to the entry of one or more search terms and one or more search criteria by a user using the input device, the processor searches the database using the entered one or more search terms and one or more search criteria and provides the search results to the user on the display.

### BRIEF DESCRIPTION OF THE DRAWINGS

FIG. 1 illustrates a system in accordance with the present invention.

FIG. 2 illustrates a method in accordance with the present invention.

FIG. 3 illustrates a screen of a user interface usable with a method in accordance with the present invention.

FIG. 4 illustrates a data structure usable in accordance with the present invention.

### DETAILED DESCRIPTION OF THE INVENTION

The following terms shall have, for the purposes of this application, the respective meanings set forth below.

Medical Product: a medical device, product, drug, vaccine, medication, or gene therapy or therapeutic product.

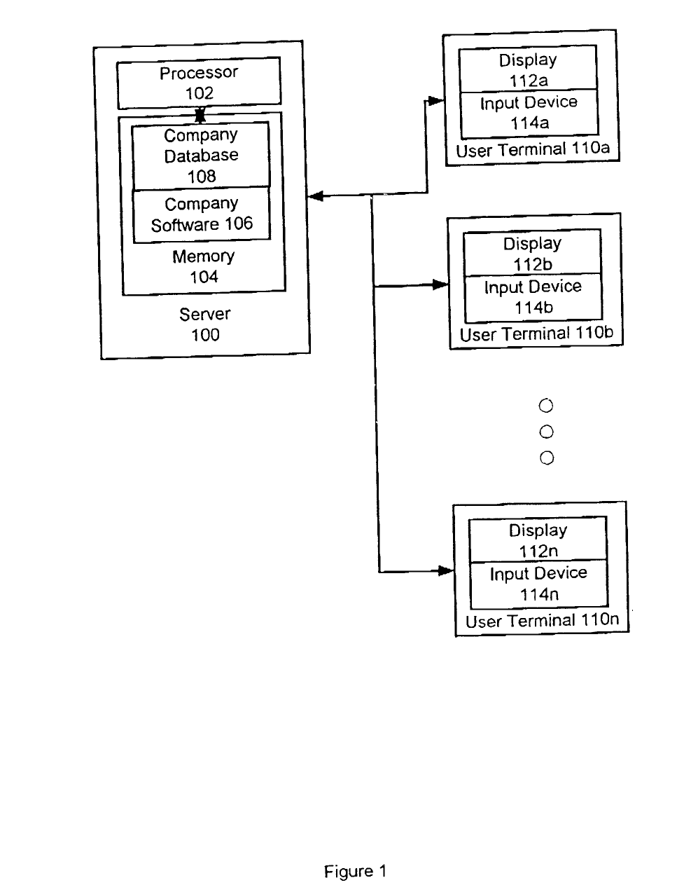

Referring to FIG. 1, a system in accordance with an embodiment of the present invention is illustrated. Server 100 can be a mainframe, minicomputer, microcomputer (such as a personal computer or workstation), or other computing device, or a plurality of computing devices connected together by a network, such as an ethernet network, or by other means, running an operating system such as a version of Microsoft Windows or a version of Unix, but is typically a Pentium or better workstation running the professional edition of Windows 2000. Server 100 includes processor 102, which can be a Pentium or better (or an equivalent or better risc-based processor) and memory 104 connected to processor 102. Memory 104 can be any form of temporary memory, such as random access memory, or permanent storage, such as a hard drive, but is typically a combination of both. Stored in memory 104 is company software 106 and company database 108.

Server 100 is in communication with a plurality of user terminals 110a through 110n over the Internet, another network, or other connection. User terminals 110a through 110n can be mainframe computers, minicomputers, microcomputers (such as personal computers or workstations), dumb terminals, network computers, personal digital assistants, or other computing devices. User terminals 110a through 110n have at least display 112a through 112n and input devices 114a through 114n (such input devices including keyboards, keypads, touchpads, touchscreens, mice, trackballs, and other pointing devices, as well as microphones). In some cases user terminals 110 have processors, hard drives, and other components, but such components are not necessary to the present invention. In some embodiments, user terminals 110a through 110n are of dissimilar types. For example, user terminal 110a might be a personal computer in communication with server 100 over the Internet, user terminal 110b might be a personal digital assistant in communication with server 100 over the Internet, and user terminal 110c might be a kiosk that includes a dumb terminal that is in communication with server 100 over a network other than the Internet.

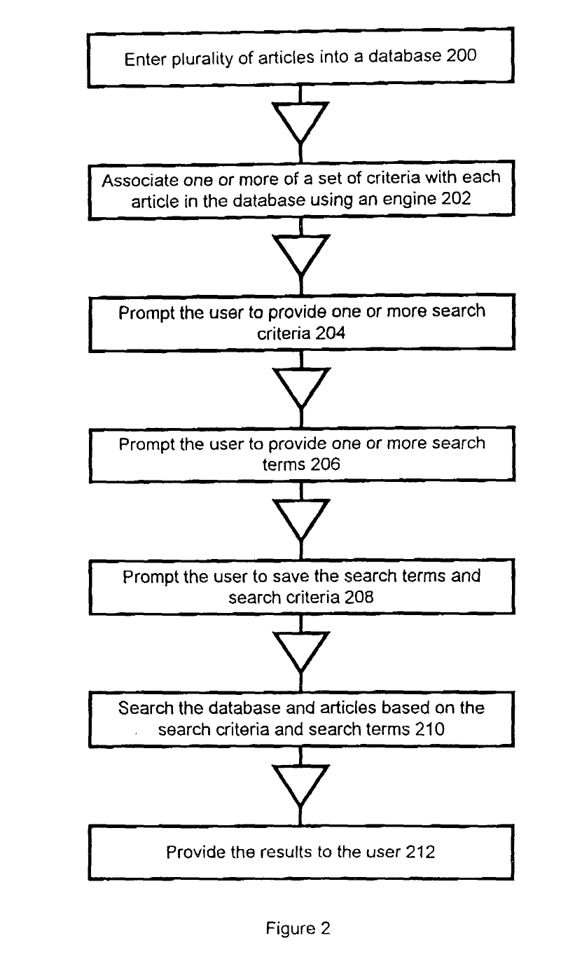

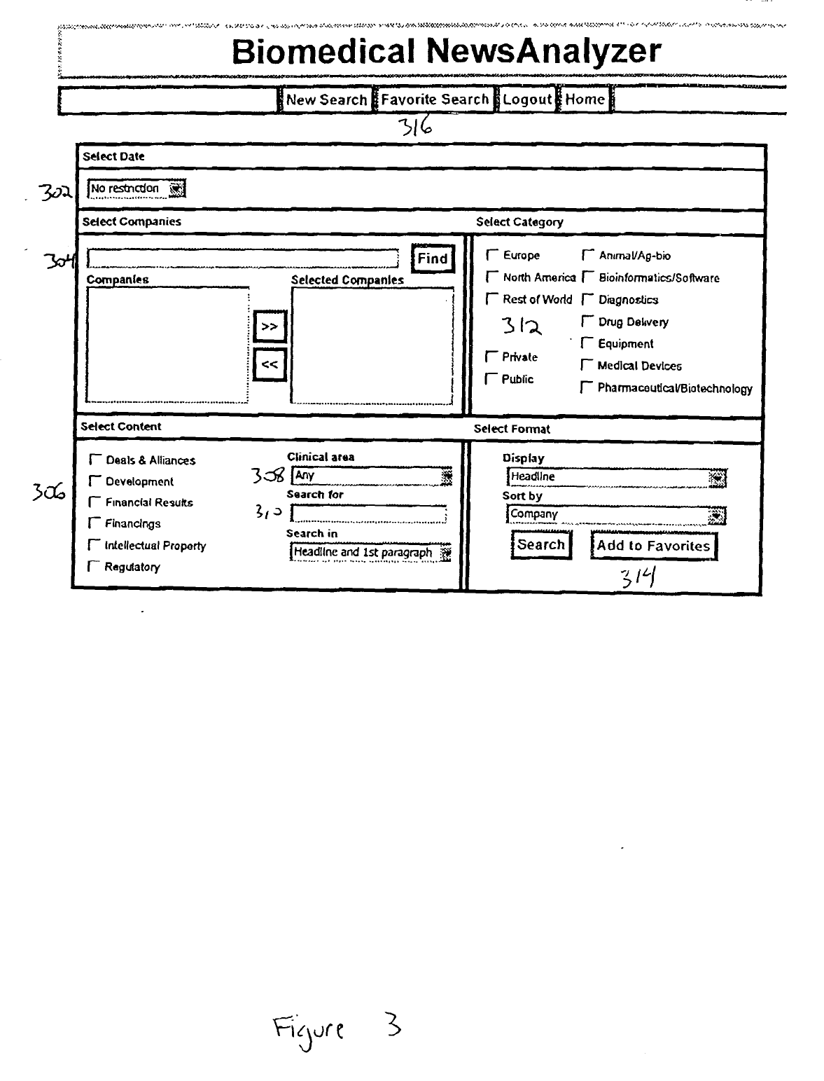

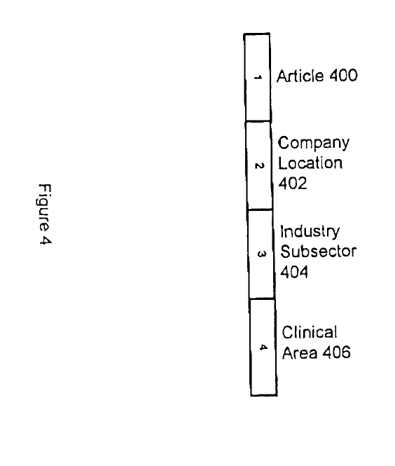

Company software 106 in an exemplary embodiment includes a user interface, preferably a graphical user interface, such as a standard Web-type interface, and methods or functions for (i) entering and categorizing articles, (ii) running searches, (iii) confirming the identity of users through the use of passwords and usernames, (iv) prompting users to enter terms and search criteria, prompting users to save search criteria, (v) prompting users to indicate desired result formats, (vi) prompting users to run searches, and (vii) providing search results to users. FIGS. 3 and 4 described below in conjunction with FIG. 2 illustrate two screens of an exemplary user interface. Company software 106 can be written in an object oriented language such as C++ or Java, a procedural language such as C, or other language. In an exemplary embodiment, company software 106 includes a version of Convera's Retrievalware program with a customized configuration in its search engine.

Company database 108 can be an off the shelf or custom relational, object oriented, or other database. In some embodiments, company database 108 can include or consist of one or more flat files, such as spreadsheet or word processing files. In an exemplary embodiment, company database 108 is an Oracle version 8.1.7 relational database. Company database 108 includes at least one table storing information relating to companies and at least one table storing information relating to articles, such as press releases. In the case of a biomedical industry application, the company table contains one record for each company including fields for company name and one or more of industry subsector, geographical location of company, public or private nature of company, and other information and a press release table contains fields such as, one or more of name of company, content type (such as intellectual property or financing), and other information. Company database 108 can also include other tables, including unrelated tables, such as tables containing information relating to users, such as tables containing users' account names, passwords, names, addresses, telephone numbers, credit card numbers, etc.

Referring to FIG. 2, a method in accordance with the present invention is illustrated. In step 200, a plurality of articles, such as all of the press releases relating to a particular industry (such as the biomedical industry, the information technology industry, or the telecommunications industry) over a period of time (such as since a particular date or over the last three years) are entered into a database, such as company database 108 by manual typing or by downloading. In an exemplary embodiment, these articles include all publicly available press releases relating to the biomedical industry. With respect to each article, a record is created in company database 108 specifying its location. The process can be automated, for example, by using a web spider scanning through the press releases or by having the press releases sent by email by the issuer.

In step 202, each article entered in step 200 is categorized. With respect to each field in the database table relating to the article (e.g., in a biomedical application, name of company, content type (such as intellectual property or financing), and category type (medical devices or drug devices)), data from the article is used to categorize the article in company database 108. Such categorization can be done manually. Preferably, for reasons of speed, it is done using a software tool. In an exemplary embodiment, the search engine, for example, retrievalware with a customized configuration is used for categorization. The customized configuration employs key words or fragments thereof to sort into predetermined categories.

Prior to step 204, a user is optionally prompted to log into an online database. The user is so prompted by providing the user with a welcome page where the user can provide a username and password which can be authenticated to ensure that the user is an authorized user of the system. In step 204, the user is prompted to provide search criteria (such as by selecting one or more content areas such as deals and alliances, development, financial results, financings, intellectual property, and regulatory, selecting a clinical area, selecting one or more categories, such as animal/ag-bio, bioinformatics/software, diagnostics, drug delivery, equipment, medical devices, pharmaceutical/biotechnology, geographical area, and public/private company, and selecting a date range). The user can be prompted as in the exemplary embodiment by providing the user with a listing of possible criteria from which the user can select or by requiring the user to enter the criteria himself. The user interface screen illustrated in FIG. 3 provides appropriate prompts in select date box 302, check boxes 306, clinical area dropdown box 308 and check boxes 312. In an exemplary embodiment, the use of at least one search criterion is necessary, but in other embodiments the use of search criteria is in any event optional in any particular search and searches can be performed without the use of any search criteria if desired (if search terms are used).

In step 206, the user is prompted to provide search terms, either by selecting terms to be searched for or by entering them. In the exemplary embodiment, the user is prompted, inter alia, to enter content (such as drugs, medical devices, and medical conditions) to be searched for in text box 310 and companies to be searched for in text box 304. Alternatively, the user can be given a list of possible terms (such as a drop down list of clinical diseases) that can be searched for. The use of search terms in a particular search is optional (if search criteria are used).

In step 208, the user is optionally prompted to save the search criteria and search terms for later reuse without the need for manual reentry of all of the search criteria and search terms. In the exemplary embodiment, the user is so prompted by providing the user with add to favorites button 314. A saved search can later be reused by clicking favorite search button 316. At this time, or at an earlier or later time, the user is optionally prompted to select a format for receiving search results, e.g., sorted by company, alphabetically, or by date, headlines only, or headlines and first paragraphs, online, word processor, spreadsheet, pdf, or other format, etc.

In step 210, the online database (defined as including both the primary information of the articles themselves and the secondary information categorizing and describing the articles) is searched for any articles matching any search criteria and search terms supplied by the user in response to steps 206 and 208. With respect to search criteria, it is the database that must be searched. An appropriate query must be constructed containing mapping every search criterion to a database field. With respect to the search terms, the article itself is searched full-text. Through the combination of full-text and category-based searching, far more accurate results are possible than are possible based on either approach alone.

In step 212, the results are provided to the user. Optionally, the user is prompted to narrow the search results by providing additional or different search terms or search criteria. Otherwise the method terminates.

FIG. 4 illustrates a data structure for storing information relating to companies in accordance with the above invention. The data structure can be an object or a database, such as a relational database or object oriented database. Block 400 contains an attribute relating to the text of an article. The location can be a file and path on a computer, an ip address, or other location. Block 402 contains an attribute relating to a company location, such as in North America, Europe, or elsewhere. Block 404 contains an attribute relating to an industry subsector such as diagnostics or drug delivery. Block 404 contains an attribute relating to a clinical area as neurology or cardiology.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

That which is claimed is:

1. A method of providing information regarding companies to users, comprising:
(a) entering a plurality of articles into an online database;
(b) prompting a user to submit a query from a remote terminal;
(c) searching the online database based on the query submitted by the user; and
(d) providing the user with information based on the results of the search,
wherein the plurality of articles comprises publicly available press releases released within a given time period relating to a particular industry group.

2. The method of claim 1, wherein the press releases are those for all or a portion of the predetermined time period.

3. The method of claim 2, wherein the portion of the predetermined time period searched is determined by the user.

4. The method of claim 2, wherein the press releases are substantially all of the press release released within the predetermined period for an industry group.

5. The method of claim 1, wherein the industry group is the biomedical industry group.

6. The method of claim 1, wherein the industry group is the telecommunications industry group.

7. The method of claim 1, wherein the industry group is the information technology industry group.

8. The method of claim 1, wherein step (b) comprises prompting the user to provide one or more search terms.

9. The method of claim 8, wherein the one of more search terms are entered by the user.

10. The method of claim 8, wherein the user selects one or more search terms from a plurality of terms.

11. The method of claim 8, wherein step (b) further comprises prompting the user to provide one or more search criteria.

12. The method of claim 11, wherein the one or more search terms are entered by the user.

13. The method of claim 11, wherein the user selects one or more search terms from a plurality of terms.

14. The method of claim 11, wherein at least one criterion relates to industry group subsector.

15. The method of claim 8 wherein step (c) comprises performing a full text search on any search terms provided by the user and utilizing an engine to map articles to criteria provided by the user.

16. A method of providing information regarding companies to users, comprising:
(a) entering a plurality of press releases into a database;
(b) associating one or more of a set of criteria with each article in the database using an engine;
(c) prompting a user to provide one or more search criteria;
(d) prompting the user to provide one or more search terms;
(e) searching the database based on the search criteria and search terms submitted by the user; and
(f) providing the user with information based on the results of the search.

17. The method of claim 16, further comprising,
(g) prompting the user to save the supplied criteria.

18. The method of claim 16, wherein the search criteria comprise a clinical disease field.

19. The method of claim 16, wherein the search criteria comprise the geographic location of a company.

20. The method of claim 16, wherein the search criteria comprise the industry subsector of a company.

21. The method of claim 16, wherein the search criteria comprise criteria relating to financial information.

22. The method of claim 16, wherein the search criteria comprise criteria relating to intellectual property.

23. The method of claim 16, wherein the search criteria comprise criteria relating to mergers and acquisitions.

24. The method of claim 16, wherein the search terms comprise the name of a company.

25. The method of claim 16, wherein the search terms comprise the name of a medical product.

26. The method of claim 25, wherein the search terms comprise the name of a medication.

27. The method of claim 16, wherein the search terms comprise the name of a medical condition.

28. A computer-readable medium having stored thereon a data structure for storing information relating to companies, comprising:
an attribute relating to the text of an article;
an attribute relating to the geographic location of the company;
an attribute relating to the industry subsector of the company; and
an attribute relating to the clinical area of the company.

29. A system for providing information relating to companies, comprising:
a processor;
a memory in communication with said processor;
a database stored in said memory;
a display in communication with said processor; and
an input device in communication with said processor,
wherein said database comprises all publicly available press releases released during a predetermined time period relating to a particular industry; and
wherein in response to the entry of one or more search terms and one or more search criteria by a user using said input device, said processor searches said database using the entered one or more search terms and one or more search criteria and provides the search results to the user on said display.
